(19) United States
(12) Patent Application Publication
(10) Pub. No.: US 2010/0030630 A1
(43) Pub. Date: Feb. 4, 2010

(54) METHODS AND APPARATUS FOR A COUPONING SYSTEM

(75) Inventors: Elizabeth Vicens, Arleta, CA (US); John J. Hilbert, Torrance, CA (US); Eric James Meyerhofer, Pasadena, CA (US); Robert Denham, Reading (GB)

Correspondence Address: FITZPATRICK CELLA HARPER & SCINTO, 1290 Avenue of the Americas, NEW YORK, NY, 10104-3800, US

(73) Assignee: FutureLogic, Inc., Glendale, CA (US)

(21) Appl. No.: 12/390,262

(22) Filed: Feb. 20, 2009

Related U.S. Application Data
(60) Provisional application No. 61/030,743, filed on Feb. 22, 2008.
(60) Provisional application No. 61/035,698, filed on Mar. 11, 2008.
(60) Provisional application No. 61/039,160, filed on Mar. 25, 2008.

(51) Int. Cl. G06Q 30/00; G06Q 50/00

(52) U.S. Cl. 705/14.12; 705/14.38

(57) ABSTRACT

Couponing system including one or more games and/or point of redemption in one or more gaming establishments and/or business entities worldwide. Each game and/or point of redemption includes a printer and bill validator, where each connect to the couponing system using a port or interface for issuance, tracking, and redemption of coupons and/or prizes and using another port or interface to connect to other systems for player tracking or issuance, tracking and redemption of game vouchers. The system offers varying prize levels with coupons issued based on player's participation and/or activity, independent of participation and/or activity of other players. Player receives coupon with value of anything including nonplaying credits. At redemption, coupon is replaced with another or new coupon with additional rewards.

### CROSS-REFERENCE TO RELATED APPLICATION(S)

The present application claims the benefit of U.S. Provisional Patent Application No. 61/030,743 filed Feb. 22, 2008, U.S. Provisional Patent Application No. 61/035,698, filed Mar. 11, 2008, and U.S. Provisional Patent Application No. 61/039,160, filed Mar. 25, 2008, and is related to U.S. patent application Ser. No. 11/502,888 entitled “METHOD AND APPARATUS FOR A PROMOTIONAL COUPONING SYSTEM”, filed Aug. 10, 2006, PCT Application PCT/US06/34694 entitled “DISTRIBUTED PROMOTIONAL COUPON SYSTEM FOR A GAMING ENVIRONMENT”, filed Sep. 6, 2006, published as WO2007030526, and PCT Application PCT/US06/38492 entitled “METHOD AND APPARATUS FOR A PROMOTIONAL COUPONING SYSTEM”, filed Sep. 30, 2006, published as WO2007041515, the contents of each of which are hereby incorporated by reference as if stated in full herein.

### BACKGROUND OF THE INVENTION

1. Field of the Invention

This invention relates to gaming, more specifically to methods and apparatus for a couponing system that includes one or a plurality of games and/or one or a plurality of point of redemption in one or a plurality of gaming establishments and/or one or a plurality of business entities anywhere in the world. Each game and/or point of redemption includes a printer and bill validator, among other peripherals. Each game and/or point of redemption and/or peripheral thereof connects to a couponing system using a port or interface for the issuance, tracking, and redemption of coupons and/or prizes and another port or interface connects to other systems for player tracking, among others or to a game or point of redemption for the issuance, tracking and redemption of game vouchers. The system offers varying prize levels with coupons issued based on player's participation and/or player activity, independent of participation and/or activity of other players. A player receives a coupon with a value of anything including nonplaying credits. At redemption, the coupon is replaced with another or new coupon with additional rewards.

2. Background

The gaming machine manufacturers have provided cash-less enabled games to the market for the last five year, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of necessary equipment for a cash-less enabled game is a printer to produce the vouchers, and a bill acceptor that supports automatic reading of the vouchers. In a cash-less enabled gaming system, when a player cashes out, the game is signaled and depending on the size of the pay out, it can either present coins in the tradition method of a slot machine, or it can cause the printers which are installed in such machines to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Over the last five years, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers, which may be used to print coupons and promotions for the captive player audiences.

### SUMMARY OF THE INVENTION

This invention identifies methods and apparatus for a couponing system that includes one or a plurality of games and/or one or a plurality of point of redemption in one or a plurality of gaming establishments and/or one or a plurality of business entities anywhere in the world. Each game and/or point of redemption includes a printer and bill validator, among other peripherals. Each game and/or point of redemption and/or peripheral thereof connects to a couponing system using a port or interface for the issuance, tracking, and redemption of coupons and/or prizes and another port or interface connects to other systems for player tracking, among others or to a game or point of redemption for the issuance, tracking and redemption of game vouchers. The system offers varying prize levels with coupons issued based on player's participation and/or player activity, independent of participation and/or activity of other players. A player receives a coupon with a value of anything including nonplaying credits. At redemption, the coupon is replaced with another or new coupon with additional rewards.

In one aspect of the invention, a couponing system includes one or a plurality of games, each game containing a bill validator, a printer, and a system for receiving and issuing information related to temporary player club registration tickets (TCT) to and/or from the bill validator and printer.

In another aspect of the invention, the connection to the PCS from each game and/or peripherals thereof, each point of redemption and/or peripheral thereof, and/or a device such as a smart box uses an Internet, WAN, LAN, dedicated communications link, or shared data line, among others.

In another aspect of the invention, the PCS and TCT system are the same system.

In another aspect of the invention, the bill validator of a game includes one or a plurality of ports or interfaces where a first port or interface of the bill validator connects to the game controller for the exchange of information related to currency inserted into the game and another port or interface connects to a TCT system for the exchange of information related to the TCTs.

In another aspect of the invention, the printer of a game includes one or a plurality of ports or interfaces where a first port or interface connects to the game controller for the exchange of information related to cashout vouchers and another port or interface connects to a TCT system for the exchange of information related to the TCTs.

In another aspect of the invention, the TCT system issues a TCT to the player using the printer as a result of signaling by the TCT system based on play metrics, player activity, or event, among others or using none of these.

In another aspect of the invention, the TCT system issues a TCT to the player using the printer as a result of signaling by the PCS, before a player cashes out, after a player cashes out, at some point during the play session, and/or during a cashout.

In another aspect of the invention, the TCT includes a barcode capable of being read by a bill validator in a game and/or at any point of redemption where the bill validator is connected to the TCT system

In another aspect of the invention, the barcode of a TCT includes a sequence number.

In another aspect of the invention, the PCS connects to the player tracking system (PTS) for the exchange of information related to TCT and/or coupons.

In another aspect of the invention, a method for progressive couponing where the player, moving to another game, inserts the TCT or progressive coupon into the bill validator of any game or point of redemption, which is connected to the PCS. The PCS, receiving signaling from the bill validator as to the TCT or progressive coupon, recognizes the sequence number, and continues the player activity session. The PCS, via a printer, issues a new TCT and/or progressive coupon to the player, along with messaging inviting the player to take the TCT and/or progressive coupon to a location such as a point of redemption where each can be scanned automatically using a bill validator or other equipment or by human operator. The PCS, connected to scanning equipment such as a bill validator at the location such as a point of redemption, allows information related to the TCT or progressive coupon to be inputted to the PCS. The PCS, communicating with player club card generating equipment at the special location, allows the transfer of player activity recorded by PCS related to the sequence number of the TCT or progressive coupon to a player club card issued to the player.

In another aspect of the invention, the PCS stores information regarding one or a plurality of coupons and/or TCT in a database, the information including issuance and redemption of such and unique identifiers, among others.

In another aspect of the invention, a couponing system includes one or a plurality of promotional coupon systems (PCS) in use at one or a plurality of gaming establishments and/or one or a plurality of other business entities anywhere in the world, where each gaming establishment and/or other business entity utilizes the PCS for the issuance, tracking, and redemption of promotional coupons and/or progressive coupons, among others.

In another aspect of the invention, a couponing system where a PCS in each gaming establishment and/or other business entity connects to a PCS in one or a plurality of gaming establishments and/or other business entity for data exchange including the issuance, tracking, and redemption of promotional coupons and/or progressive coupons, among others.

In another aspect of the invention, the connection and/or data exchange with each PCS and/or peripheral thereof is secured.

In another aspect of the invention, a couponing system includes one or a plurality of games at one or a plurality of gaming establishments, each game containing, among others, a printer and a bill validator, each with one or a plurality of ports or interfaces, wherein each game, printer and/or bill validator connects to the PCS and/or other systems in use at one or a plurality of gaming establishments and/or other business entities for data exchange including the issuance, tracking, and redemption of promotional coupons and progressive coupons, among others.

In another aspect of the invention, the PCS is in communication with other systems in use at one or plurality of gaming establishments and/or business entities, such as a point-of-sale system (POS), player tracking system (PTS) and cash-out voucher system, among others.

In another aspect of the invention, the bill validator of a game or point of redemption includes one or a plurality of ports or interfaces where a port or interface of the bill validator connects to the game controller or other system for the exchange of information related to currency inserted into the game and another port or interface connects to the PCS for data exchange including information related to coupons.

In another aspect of the invention, the printer of a game or point of redemption includes one or a plurality of ports or interfaces where a port or interface connects to the game controller or other system for the exchange of information related to cashout vouchers and another port or interface connects to the PCS for the exchange of information related to coupons.

In another aspect of the invention, the PCS issues one or a plurality of coupons to a player or players at a gaming establishment using the printer as a result of signaling by the PCS based on play metrics, player activity, or event, among others or using none of these.

In another aspect of the invention, the PCS issues one or a plurality of coupons to a player or players at a gaming establishment using the printer as a result of signaling by the PCS, before a player cashes out, after a player cashes out, at some point during the play session, and/or during a cashout.

In another aspect of the invention, the PCS issues one or a plurality of coupons based on a player's participation and/or a player activity, independent of the participation and/or activity of other players.

In another aspect of the invention, a couponing system includes one or a plurality of points of redemption in one or a plurality of gaming establishments and/or one or a plurality of business entities; each point of redemption containing, among others, a printer and bill validator, each with one or a plurality of ports or interfaces, wherein each point of redemption connects to the PCS and/or other systems in use at one or a plurality of gaming establishments and/or other business entities.

In another aspect of the invention, the PCS issues one or a plurality of coupons to a patron at a business entity as a result of signaling by the PCS based on purchase metrics, purchase activities, or event, among others or using none of these.

In another aspect of the invention, the PCS issues one or a plurality of coupons based on a patron's participation and/or patron activity in relation to the other business entity, independent of the participation and/or activity of other patrons.

In another aspect of the invention, the PCS issues one or a plurality of coupons to a player or players at a gaming establishment wherein the coupons are used and redeemed at a game or any point of redemption of the same or one or a plurality of other gaming establishments.

In another aspect of the invention, the PCS issues one or a plurality of coupons at a gaming establishment wherein the coupons are used and redeemed at any point of redemption of one or a plurality of business entities.

In another aspect of the invention, the PCS issues one or a plurality of coupons at a business entity wherein the coupons are used and redeemed at any point of redemption of the same or one or a plurality of other business entities.

In another aspect of the invention, the PCS issues one or a plurality of coupons at a business entity wherein the coupons are used and redeemed at a game or any point of redemption of one or a plurality of gaming establishments.

In another aspect of the invention, the PCS continually supplies coupons to one or a plurality of patrons, where a patron is tracked using a frequent buyer program, membership rewards program, or anonymously.

In another aspect of the invention, a local host such as a hub connects to the PCS and to one or a plurality of games and/or peripherals thereof and/or one or a plurality of point of redemption and/or peripherals thereof such as printer, bill validator and/or a device such as a smart box.

In another aspect of the invention, a device such as a smart box connects to the PCS and/or other system(s) and to a game and/or peripherals thereof such as printer and bill validator, or to a point of redemption and/or peripherals thereof, the smart box internal or external to the game or point of redemption.

In another aspect of the invention, one or a plurality of games and/or point of redemption in use at one or a plurality of gaming establishments and/or other business entities and/or peripherals thereof such as a printer and bill validator connect to the PCS using a direct connection.

In another aspect of the invention, each game and/or peripherals thereof such as a printer and bill validator, each point of redemption and/or peripherals thereof, each device such as a smart box are addressable using an IP address.

In another aspect of the invention, a bill validator in a game and/or point of redemption reads the barcode of a coupon for validation and redemption purposes.

In another aspect of the invention, the PCS continually supplies coupons to one or a plurality of players, where the player is known and tracked in a player tracking system (PTS) or not known in a PTS or anonymous.

In another aspect of the invention, the PCS continually supplies coupons to one or a plurality of players, where the player is tracked using an anonymous PTS.

In another aspect of the invention, the PCS issues one or a plurality of coupons using indicia including a barcode, one or a plurality of text, and/or one or a plurality of graphic images, among others, wherein the indicia is generated by the printer.

In another aspect of the invention, the barcode generated on a coupon includes a sequence number.

In another aspect of the invention, the PCS issues one or a plurality of coupons based on varying prize levels of one or a plurality of promotions.

In another aspect of the invention, the PCS issues one or a plurality of coupons based on one or a plurality of promotions.

In another aspect of the invention, the PCS issues one or a plurality of coupons to replace an already issued coupon thereby adding additional value to the coupon and whereby the already issued coupon is considered redeemed or null and void.

In another aspect of the invention, the PCS stores information regarding one or a plurality of promotions in a database, the information including issuance and redemption of such and/or unique identifiers, among others.

In another aspect of the invention, the PCS stores information regarding one or a plurality of promotional campaigns in a database, the information including usage and/or unique identifiers, among others.

### BRIEF DESCRIPTION OF THE DRAWINGS

These and other features, aspects, and advantages of the present invention will become better understood with regard to the following description and accompanying drawings where:

FIG. 1 is a block diagram of components used in a couponing system in accordance with an exemplary embodiment of the present invention;

FIG. 2 is a block diagram of a game using a device such as a smart box in accordance with an exemplary embodiment of the present invention;

FIG. 3 is a block diagram of a couponing system using a device such as a smart box and a local host connection in accordance with an exemplary embodiment of the present invention;

FIG. 4 is a block diagram of a couponing system using a local host connection in a plurality of gaming establishments in accordance with an exemplary embodiment of the present invention;

FIG. 5 is a block diagram of a couponing system with temporary player club registration tickets system in accordance with an exemplary embodiment of the present invention;

FIG. 6 is a flow chart of a progressive coupon issuance and redemption process in accordance with an exemplary embodiment of the present invention;

FIG. 7 is a flow chart of a TCT issuance and redemption process in accordance with an exemplary embodiment of the present invention;

FIG. 8 is a diagram of a couponing system in accordance with an exemplary embodiment of the present invention;

FIG. 9 is a flow chart of a load, check, and verify CRC process for a promotional campaign in accordance with an exemplary embodiment of the present invention;

FIG. 10 is an illustration of an exemplary promotional database, which includes defined coupons and triggers in accordance with an exemplary embodiment of the present invention;

FIG. 11 is an illustration of an exemplary point-of-sale database, which includes metrics and triggers in accordance with an exemplary embodiment of the present invention;

FIG. 12 is a flow chart of a purchase detection and coupon issuance process in accordance with an exemplary embodiment of the present invention; and

APPENDIX A is a list of definitions of terms as used herein.

Identically labeled elements appearing in different ones of the figures refer to the same elements but may not be referenced in the description for all figures.

### DETAILED DESCRIPTION

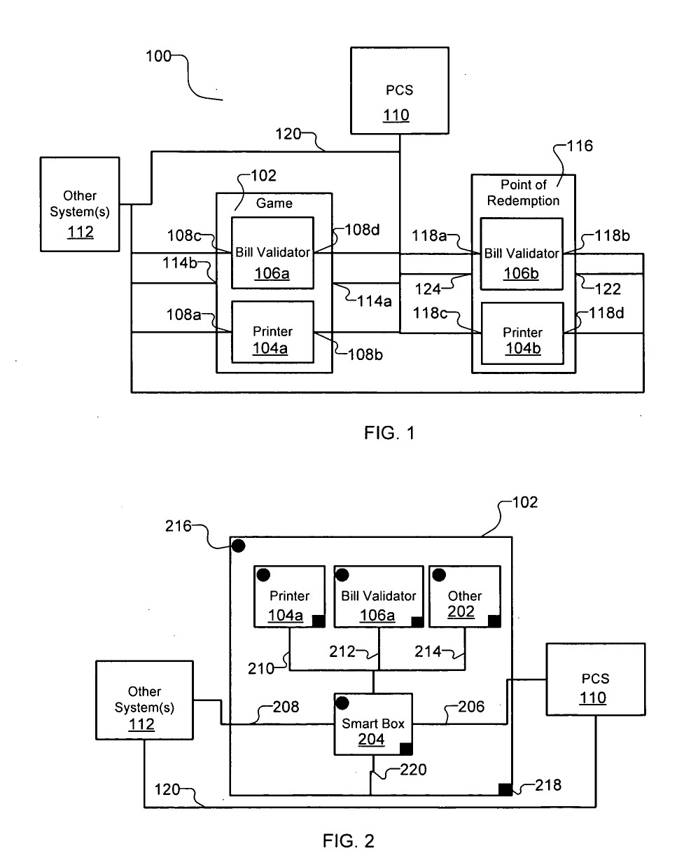

FIG. 1 is a block diagram of components used in a couponing system in accordance with an exemplary embodiment of the present invention. Any component can be optional.

A couponing system 100 includes one or a plurality of games 102, each game containing, among other peripherals not shown, but known to those skilled in the art, a printer 104a and a bill validator 106a, each with one or a plurality of ports or interfaces such as 108a, 108b, 108c, and 108d. Each game, printer and/or bill validator connects to the Promotional Coupon System (PCS) 110 and/or other system(s) 112 in use at a gaming establishment using a port or interface such as 108b, 108d and 114a for the issuance, tracking and redemption of coupons and/or prizes offered during couponing such as progressive couponing as well as a port or interface such as 108a, 108c, and 114b to other system(s) for player tracking and play tracking, among others. The couponing system offers varying prize levels with coupons issued based on player's participation and/or player activity, independent of participation and/or activity of other players. A player receives a coupon with a value of anything including nonplaying credits. At redemption, the coupon is replaced with another or new coupon with additional rewards. Additional information on a Promotional Coupon System (PCS) and components thereof is more fully detailed in PCT Application PCT/US06/34694 entitled “DISTRIBUTED PROMOTIONAL COUPON SYSTEM FOR A GAMING ENVIRONMENT”, filed Sep. 6, 2006, published as WO2007030526, and PCT Application PCT/US06/38492 entitled “METHOD AND APPARATUS FOR A PROMOTIONAL COUPONING SYSTEM”, filed Sep. 30, 2006, published as WO2007041515, the contents of each of which are hereby incorporated by reference as if stated in full herein.

Additionally, a couponing system 100 includes one or a plurality of point of redemption 116, each with a bill validator 106b and printer 104b, among other peripherals not shown but known to those skilled in the art.

Other system(s) 112 include systems in use at a gaming establishment, such as a Player Tracking System (PTS) 504 (of FIG. 5), Cash-Out Voucher System, and Point-of-Sale System, among others.

The bill validator of a game 106a or point of redemption 106b includes one or a plurality of ports or interfaces where a first port or interface of the bill validator such as 108c and 118b connects to other system(s) 112 and/or the game controller (not shown) for the exchange of information related to currency inserted into the game and another port or interface such as 108d and 118a connects to the PCS for the exchange of information related to couponing and/or progressive coupons.

In another embodiment, a bill validator such as 106a includes one port or interface such as 108d, which connects to PCS 110 and/or other system(s) 112 and/or the game controller (not shown).

In another embodiment, a bill validator such as 106a includes one or a plurality of ports or interfaces where a first port or interface such as 108d connects to the PCS 110 and/or other systems 112 and another port or interface such as 108c connects to other systems 112 and/or the game 102 and/or game controller (not shown).

The bill validator in a game 106a and/or a point of redemption 106b reads one or a plurality of barcodes of a coupon such as a progressive coupon for validation and redemption purposes. Data regarding the validation and redemption is transmitted to and from the bill validator and PCS 110. Additionally, one or a plurality of barcodes generated on a progressive coupon include a sequence number and/or other number scheme, which can be used to associate multiple coupons issued to one player.

In another embodiment, a sequence number and/or other number scheme permits the tracking of a player where the player is known or anonymous in a player tracking system PTS 504 (of FIG. 5), among others.

In another embodiment, a coupon such as a progressive coupon includes one or a plurality of barcodes. One or all barcodes can include a sequence number and/or other number scheme. Additionally, one or a plurality of barcodes is selected from a group of barcode types including 2d barcodes, Code 39 barcodes, and Code 128 barcodes, among others.

The printer of a game 104a or point of redemption 104b includes one or a plurality of ports or interfaces where a first port or interface such as 108a and 118d connects to other system(s) 112 and/or the game controller (not shown) for the exchange of information related to cashout vouchers and another port or interface such as 108b and 118c connects to the PCS 110 for the exchange of information related to the coupons. Data regarding the issuance is transmitted to and from a printer and PCS. Additional information on an exemplary embodiment of the printer and components thereof is more fully detailed in U.S. patent application Ser. No. 10/402,112, filed Mar. 31, 2003, entitled “METHOD & APPARATUS FOR A GAMING PROMOTIONAL PRINTER” published as U.S. Patent Application Publication Number US2004095604, the contents of which are hereby incorporated by reference as if stated in full herein.

In another embodiment, a printer such as 104a includes one port or interface such as 108b, which connects to PCS 110 and/or other system(s) 112 and/or the game controller (not shown).

In another embodiment, a printer such as 104a includes one or a plurality of ports or interfaces where a first port or interface 108b connects to the PCS 110 and another port or interface 108a connects to other systems 112.

In another embodiment, a printer such as 104a includes one or a plurality of ports or interfaces where a first port or interface 108b connects to the PCS 110 and/or other systems 112 and other port or interface 108a connects to other systems 112 and/or the game 102 and/or game controller (not shown).

The connection to the PCS 110 from each game 102 and/or peripheral thereof, each point of redemption 116 and/or peripheral thereof, and/or a device such as a smart box 204 (of FIG. 2) uses an Internet, WAN, LAN, dedicated communications link, or shared data line, among others.

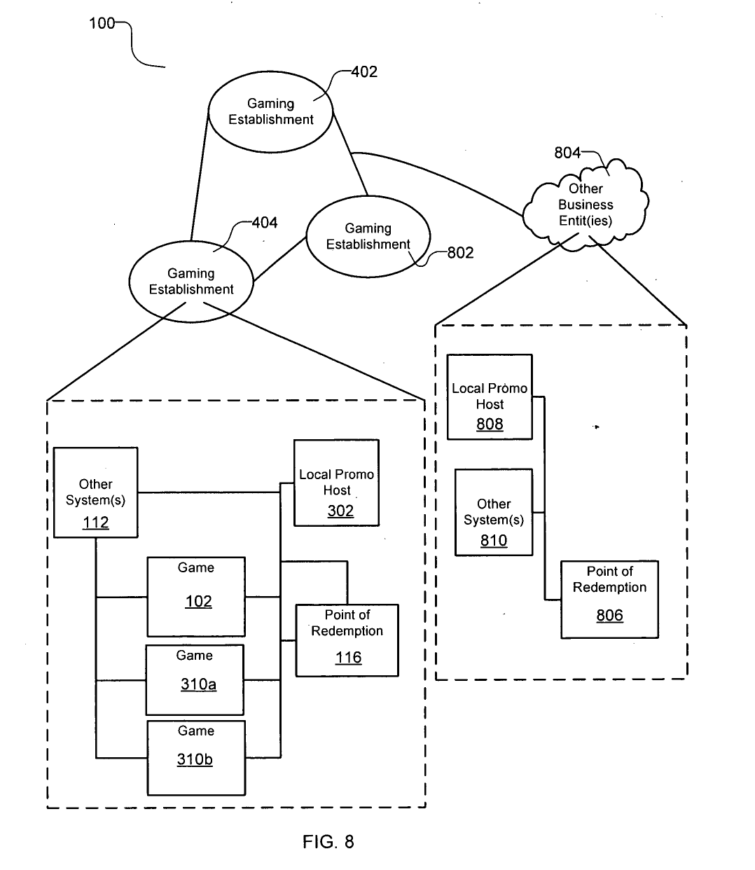

The PCS 110 is in communication with other system(s) 112 in use at a gaming establishment or other business entity 804 (of FIG. 8), such as a player tracking system (PTS) 504 (of FIG. 5) and cash-out voucher system, among others for the data transmission and exchange of information related to coupons and/or promotions. This connection is a direct connection 120 or through a game 102 or point of redemption 116.

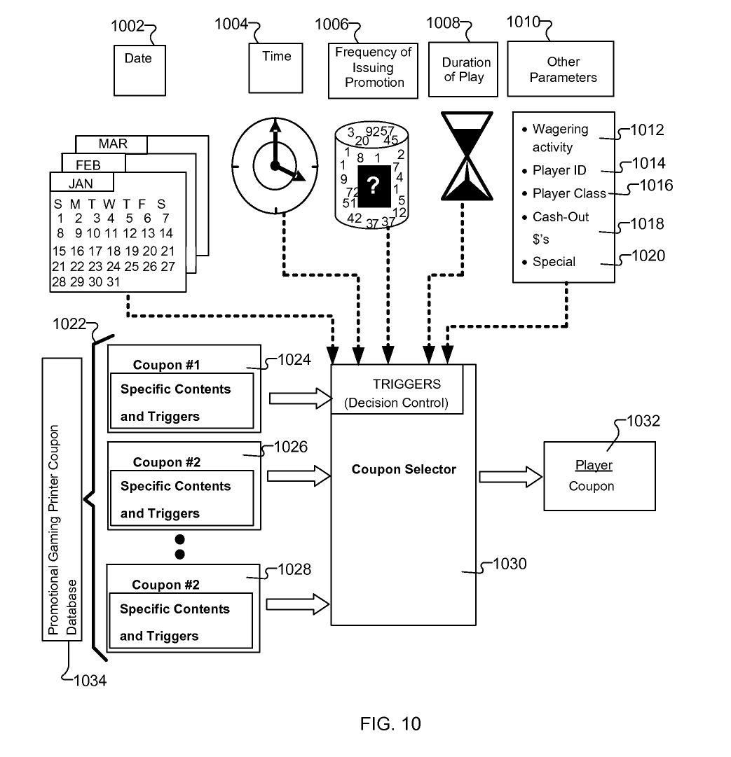

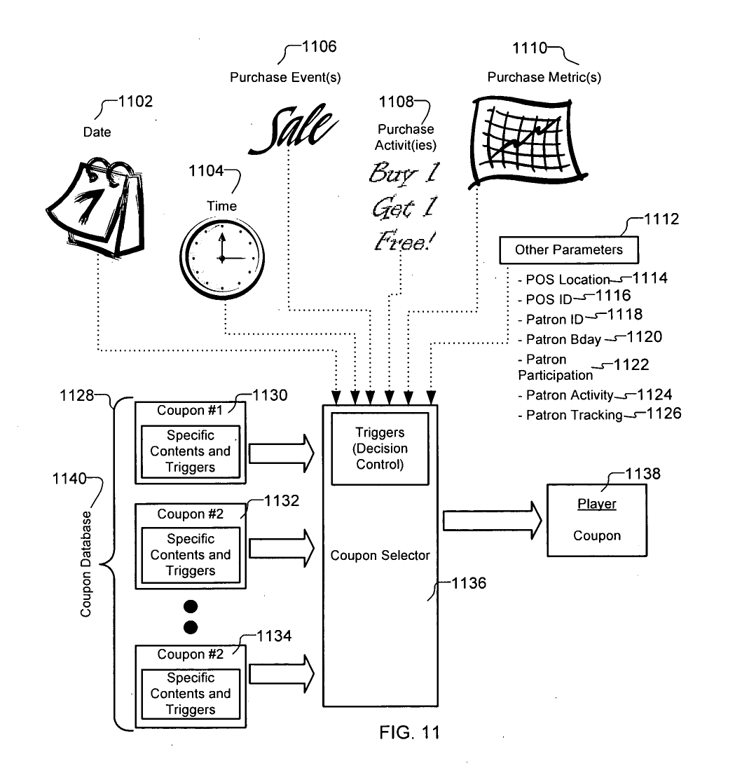

In one embodiment, the PCS 110 issues one or a plurality of coupons such as progressive coupons to a player using a printer such as 104a as a result of signaling by the PCS based on play metrics, player activity, coupon triggers, and/or event among others or using none of these or based on none of these. Additional information is disclosed in FIG. 10 and FIG. 11.

In another embodiment, the PCS 110 issues one or a plurality of coupons such as progressive coupons to a player using a printer such as 104a as a result of signaling by the PCS, before a player cashes out, after a player cashes out, at some point during the play session, and/or during a cashout. Additional information is disclosed in FIG. 10 and FIG. 11.

In another embodiment, the PCS 110 continually supplies progressive coupons to one or a plurality of players, where a player is known in a PTS 504 (of FIG. 5) or is anonymous.

In another embodiment, the PCS 110 continually supplies progressive coupons to one or a plurality of players, where a player is tracked using an anonymous player tracking system.

In another embodiment, the PCS 110 issues one or a plurality of progressive coupons using indicia including one or a plurality of barcodes, one or a plurality of text, and/or one or a plurality of graphic images, among others, wherein the indicia is generated by a printer such as 104a.

In another embodiment, a couponing system 100 includes one or a plurality of games 102, each game containing bill validator 106a, a printer 104a, and a Temporary Club Ticket (TCT) system 502 (of FIG. 5) for receiving and issuing information related to temporary player club registration tickets to and/or from the bill validator and printer. Further details are disclosed in FIG. 5 as well as throughout this specification.

In another embodiment, the PCS 110 connects 120 to other system(s) 112 such as the PTS 504 (of FIG. 5) for the exchange of information related to temporary player club registration tickets and/or progressive coupons. Additional details are disclosed in FIG. 5 as well as throughout this specification.

In the operation of one embodiment, a player, moving to another game 102, inserts the progressive coupon into the bill validator 106a of any game, which is connected to the PCS 110. The PCS, receiving signaling from the bill validator as to the progressive coupon, recognizes the sequence number, and continues the player activity session. The PCS, via a printer such as 104a, issues a new progressive coupon to the player. Additionally, the PCS issues a temporary player club registration ticket along with messaging inviting the player to take the temporary player club registration ticket and/or progressive coupon to a location such as a point of redemption 116 where each can be scanned automatically using a bill validator 106b or other equipment or by human operator. The PCS, connected to scanning equipment such as a scanner 506 (of FIG. 5) or a bill validator at the location such as a point of redemption, allows information related to the temporary player club registration ticket or progressive coupon to be inputted or transmitted to the PCS. The PCS, communicating with player club card generating equipment 512 (of FIG. 5) at the location, allows the transfer of player activity recorded by PCS related to the sequence number of the temporary player club registration ticket and/or progressive coupon to a player club card issued to the player by the PTS 504 (of FIG. 5). Additional details are disclosed in FIG. 5 as well as throughout this specification.

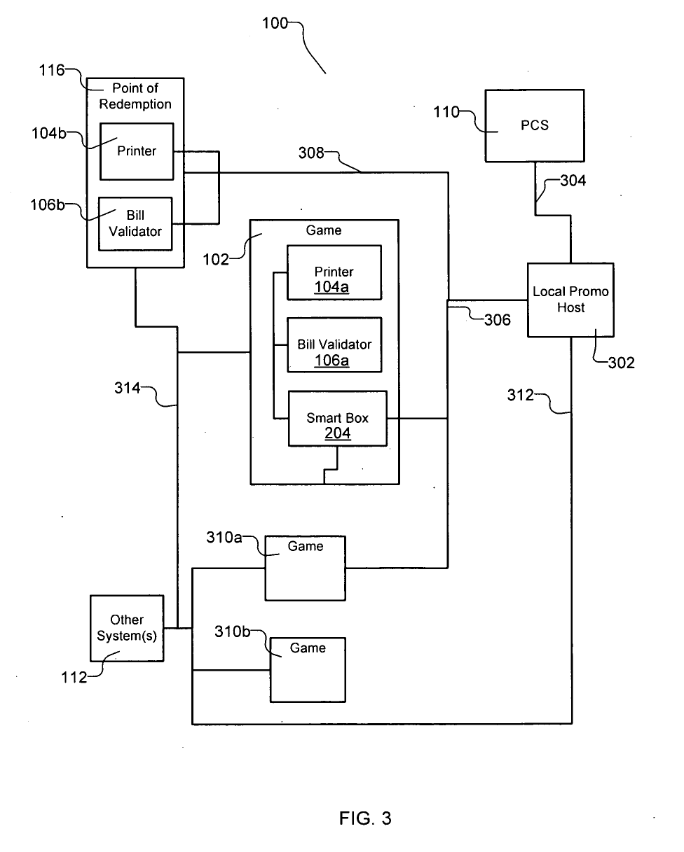

In the operation of another embodiment, a player moving to another game such as 310a and 310b (of FIG. 3), cashes out of the current game 102 in play and receives a game cashout voucher, temporary player club registration ticket and/or progressive coupon. Data from the game cashout is transmitted to the PCS 110 and/or other systems 112. Additionally, data for the issuance of the temporary player club registration ticket and/or a progressive coupon also is transmitted to the PCS and/or other systems.

Additionally, the point of redemption 116 includes one or a plurality of ports or interfaces where a first port or interface 124 connects to the PCS 110 and another port or interface connects to other systems 112.

FIG. 2 is a block diagram of a game using a device such as a smart box in accordance with an exemplary embodiment of the present invention. Any component can be optional.

The PCS, game, point of redemption, other system(s), printer, bill validator, local promo host in this illustration are previously disclosed in FIG. 1 as well as throughout this specification.

Illustrated is a game 102 including a printer 104a, bill validator 106a, other 202, smart box 204, along with the PCS 110, and other system(s) 112 of a couponing system 100 (of FIG. 1). In another embodiment, the printer, bill validator, other, and smart box are peripherals of a point of redemption 116 (of FIG. 1).

Additionally, a device such as a smart box 204 connects 206 to the PCS 110 and/or connects 208 to other system(s) 112 and connects 220 to a game 102 and/or peripherals thereof such as a printer connection 210, bill validator connection 212, and other connection 214. Additionally, the smart box is internal or external to a game or point of redemption.

In one embodiment, one or a plurality of games 102 and/or point of redemption 116 (of FIG. 1) in use at one or a plurality of gaming establishments and/or peripherals thereof connect to the PCS 110 using a direct connection.

Additionally, the PCS 110 connects 120 to other systems 112 as previously disclosed in FIG. 1 as well as throughout this specification.

Additionally, the connection to the PCS 110 from each game 102 and/or peripheral thereof, each point of redemption 116 (of FIG. 1) and/or peripheral thereof, and/or a device such as a smart box 204 uses an Internet, WAN, LAN, dedicated communications link, or shared data line, among others. In one embodiment, the connection and/or data exchange with each PCS and/or peripheral thereof is secured.

In another embodiment, the connection to the PCS 110 is made from one or a plurality of games 102 and/or peripherals thereof and/or one or a plurality of point of redemption 116 (of FIG. 1) and/or peripherals thereof without using a local host such as Local Promo Host 302 (of FIG. 3).

Each game 102 and/or peripherals, thereof such as a printer 104a, bill validator 106a, other 202, each point of redemption 116 (of FIG. 1) and/or peripherals thereof, each device such as a smart box 204, are addressable and/or sub-addressable using an IP address 216 and/or are web enabled 218.

In another embodiment each of the previously described apply to a point of redemption 116 (of FIG. 1) and/or peripherals thereof.

FIG. 3 is a block diagram of a couponing system using a device such as a smart box and a local host connection in accordance with an exemplary embodiment of the present invention. Any component can be optional.

The components in this illustration are previously disclosed in FIG. 1 and FIG. 2 and throughout this specification.

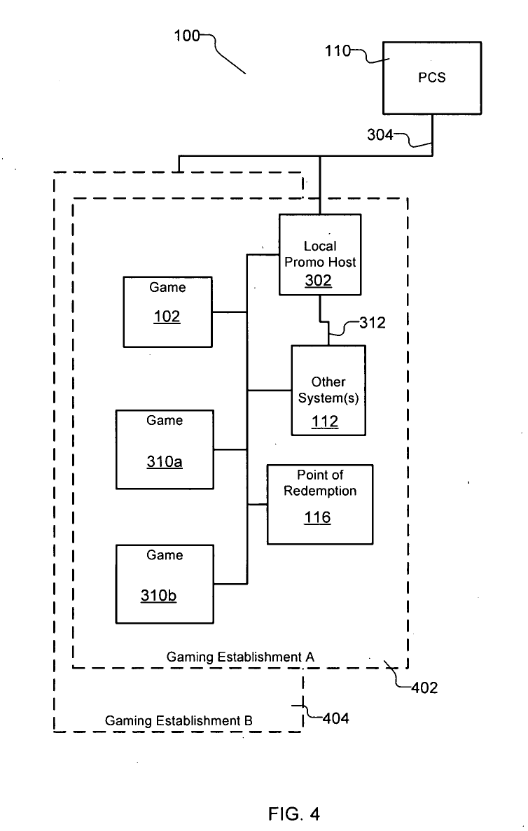

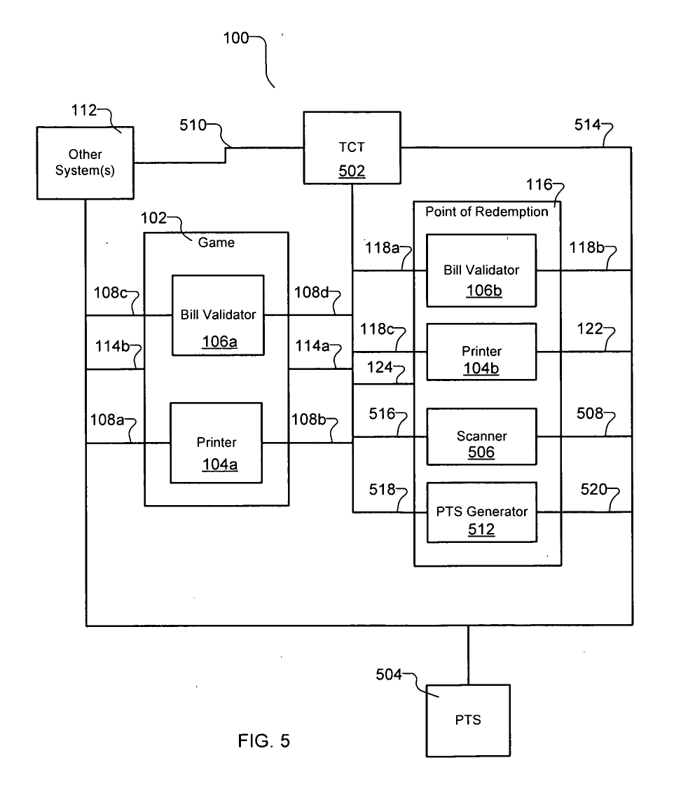

In this embodiment, a couponing system 100 includes a local host 302. The local host such as a hub reduces bandwidth and data transmission requirements needed, for example connecting to another PCS 110 in another gaming establishment 402 and 404 (both of FIG. 4) and other business entities 804 (of FIG. 8). The local host connects 304 to the PCS 110 and connects 306 to one or a plurality of games such as 102, 310a and 310b, and/or peripherals thereof such as printer 104a, bill validator 106a, and smart box 204 and/or connects 308 to one or a plurality of point of redemption 116 and/or peripherals thereof such as printer 104b and bill validator 106b for data exchange.

Other systems 112 connects 314 to one or a plurality of games such as 102, 310a and 310b, and/or peripherals thereof such as printer 104a, bill validator 106a, and smart box 204 and/or one or a plurality of point of redemption 116 and/or peripherals thereof such as printer 104b and bill validator 106b for data exchange.

In another embodiment, the local host 302 of a couponing system 100 connects 312 to other system(s) 112 for the exchange of information related to coupons such as progressive couponing and temporary player club registration ticket.

FIG. 4 is a block diagram of a couponing system using a local host connection in a plurality of gaming establishments in accordance with an exemplary embodiment of the present invention. Any component can be optional.

The components in this illustration are previously disclosed in FIG. 1 and FIG. 2 and throughout this specification.

In this embodiment, a couponing system 100 includes one or a plurality of games 102, 310a and 310b and/or peripherals thereof and/or one or a plurality of point of redemption 116 and/or peripherals thereof in use at one or a plurality of gaming establishments such as Gaming Establishment A 402 and Gaming Establishment B 404 connect 304 to the PCS 110 using a local host 302 such as a hub for data exchange.

In another embodiment, the local host 302 connects to other system(s) 112 for the exchange of information related to coupons such as progressive couponing and temporary player club registration ticket, the connection either through a game such as 102, a point of redemption 116, or a direct connection such as 312.

In another embodiment, the PCS 110 issues one or a plurality of coupons such as progressive coupons wherein the coupons are redeemed at a game 102 and/or any point of redemption 116 at one or a plurality of gaming establishments 402 and 404.

FIG. 5 is a block diagram of a couponing system with temporary player club registration tickets system in accordance with an exemplary embodiment of the present invention. Any component can be optional.

The components in this illustration are previously disclosed in FIG. 1 and FIG. 2 as well as throughout this specification.

In this embodiment, a couponing system 100 includes one or a plurality of games 102 and one or a plurality of point of redemption 116 and a TCT system 502 for receiving and issuing information related to temporary player club registration tickets to and/or from a bill validator such as 106a and 106b and printer such as 104a and 104b. Each game and/or point of redemption includes a bill validator and a printer.

In another embodiment, the PCS 110 (of FIG. 1) and TCT system 502 are the same system, forming the couponing system 100.

Other system(s) 112 include systems in use at a gaming establishment, such as a Cash-Out Voucher System, and Point-of-Sale System, among others.

One or a plurality of point of redemption 116 includes a scanner 506, which connects 508 to the PTS 504.

The bill validator of a game 106a or point of redemption 106b includes one or a plurality of ports or interfaces where a first port or interface such as 108c and 118b connects to other system(s) 112 and/or the game controller (not shown) for the exchange of information related to currency inserted and another port or interface such as 108d and 118a connects to the TCT 502 for the exchange of information related to temporary player club registration tickets and/or coupons such as progressive coupons.

In another embodiment, a bill validator such as 106a includes one port or interface such as 108d, which connects to TCT 502 and/or other system(s) 112 and/or a game controller (not shown).

In another embodiment, a bill validator such as 106a includes one or a plurality of ports or interfaces where a first port or interface such as 108d connects to the TCT 502 and/or other systems 112 and another port or interface such as 108c connects to other systems and/or the game 102 and/or game controller (not shown).

The bill validator in a game 106a and/or at a point of redemption 106b reads one or a plurality of barcodes of a temporary player club registration tickets and/or coupon such as a progressive coupon. Additionally, one or a plurality of barcodes generated includes a sequence number and/or other number scheme, which can be used to associate multiple coupons issued to one player.

In another embodiment, the sequence number and/or other number scheme permits the tracking of a player where the player is known or anonymous in a PTS 504, among others.

In another embodiment, a coupon such as progressive coupon includes one or a plurality of barcodes. One or all barcodes can include a sequence number and/or other number scheme. Additionally, one or a plurality of barcodes is selected from a group of barcode types including 2d barcodes, Code 39 barcodes, and Code 128 barcodes, among others.

The printer of a game 104a or point of redemption 104b includes one or a plurality of ports or interfaces where a first port or interface such as 108a connects to other system(s) 112 and/or the game controller (not shown) for the exchange of information related to cashout vouchers and another port or interface such as 108b connects to the TCT 502 for the exchange of information related to the temporary player club registration tickets and/or coupons such as progressive coupons.

In another embodiment, a printer such as 104a includes one port or interface such as 108b, which connects to TCT 502 and/or other system(s) 112 and/or the game controller (not shown).

In another embodiment, a printer such as 104a includes one or a plurality of ports or interfaces where a first port or interface 108b connects to the TCT 502 and another port or interface 108a connects to others systems 112.

In another embodiment, a printer such as 104a includes one or a plurality of ports or interfaces where a first port or interface 108b connects to the TCT 502 and/or other systems 112 and other port or interface 108a connects to other systems 112 and/or the game 102 and/or game controller (not shown).

TCT 502 is in communication 510 with other system(s) 112 in use at a gaming establishment. This connection is a direct connection 510 or through a game 102 or point of redemption 116.

In one embodiment, the TCT system 502 issues a temporary player club registration tickets to a player using a printer such as 104a as a result of signaling by the TCT system based on play metrics, player activity, or event, among others or using none of these. Additional information is disclosed in FIG. 10 and throughout this specification.

In another embodiment, the TCT system 502 issues a temporary player club registration tickets to a player using a printer such as 104a as a result of signaling by the TCT, before a player cashes out, after a player cashes out, at some point during the play session, and/or during a cashout. Additional information is disclosed in FIG. 10 and throughout this specification.

In another embodiment, the temporary player club registration tickets include one or a plurality of barcodes capable of being read by a bill validator in a game 106a and/or at any point of redemption 106b where the bill validator is connected to the TCT system.

In another embodiment, the TCT 502 connects to the PTS 504 for the exchange of information related to temporary player club registration tickets and/or progressive coupons, the connection is a direct connection 514 or through a game 102 or point of redemption 116.

In another embodiment, the game 102 connects 114a to the TCT System 502 and connects 114b to other systems 112.

In another embodiment, the point of redemption 116 connects 124 to the TCT System 502 and connects 122 to other systems 112.

In the operation of one embodiment, a player, moving to another game 102, inserts the temporary player club registration tickets or progressive coupon into the bill validator of any game 106a, which is connected to the TCT 502. The TCT, receiving signaling from the bill validator as to the temporary player club registration tickets or progressive coupon, recognizes the sequence number, and continues the player activity session. The TCT, via a printer such as 104a, issues a new temporary player club registration tickets or progressive coupon to the player. Additionally, the TCT issues a temporary player club registration tickets along with messaging inviting the player to take the temporary player club registration tickets and/or progressive coupon to a location such as a point of redemption 116 where each can be scanned automatically using a bill validator 106b or other equipment such as 506 or by human operator. The TCT, connected 516 to scanning equipment such as a scanner 506 or bill validator at the location such as a point of redemption, allows information related to the temporary player club registration tickets or progressive coupon to be inputted or transmitted to the TCT. The TCT, communicating 518 with player club card generating equipment 512 at the location, allows the transfer 520 of player activity recorded by the TCT related to the sequence number of the temporary player club registration tickets or progressive coupon to a player club card issued to the player.

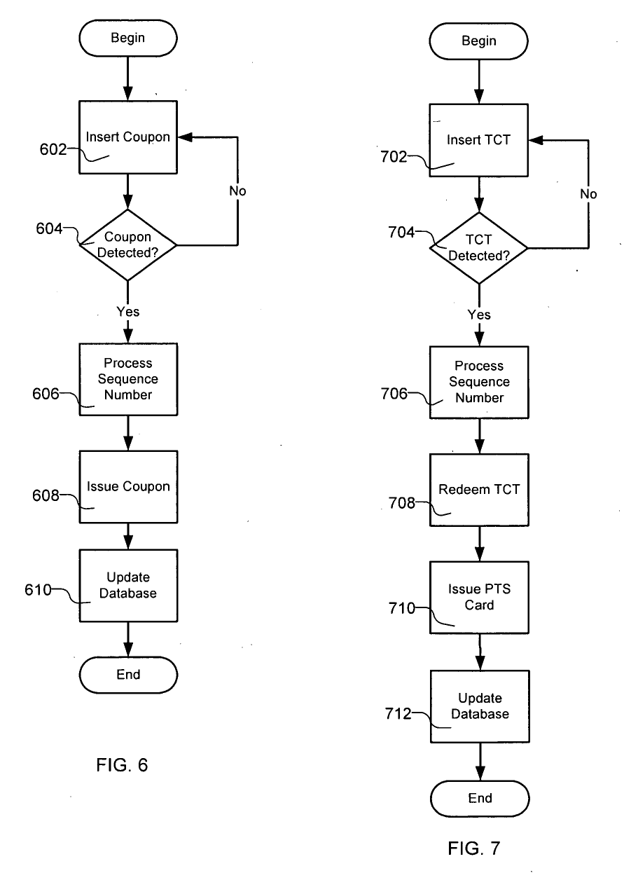

FIG. 6 is a flow chart of a progressive coupon issuance and redemption process in accordance with an exemplary embodiment of the present invention.

The components in this illustration and/or descriptions thereof are previously disclosed in FIG. 1 and FIG. 2 as well as throughout this specification.

The process begins with insert coupon 602 where a player inserts a progressive coupon into the bill validator of a game 106a or point of redemption 106b (each of FIG. 1). If the coupon is detected 604, the process continues with process sequence number 606 where the couponing system 100 (of FIG. 1) can associate a sequence number and/or other number scheme to associate multiple coupons issued to a player.

If a coupon is not detected, the process returns to insert coupon 602 where the couponing system 100 (of FIG. 1) waits for a coupon insertion.

Once the sequence number is processed 606, the process continues with issue coupon 608 where one or a plurality of additional progressive coupons is issued to the player.

The process then continues with update database 610 where the PCS 110 (of FIG. 1) database is updated, after which the process ends.

The information stored in the PCS 110 (of FIG. 1) database includes information on the issuance and redemption of such and unique identifiers, among others for coupons and/or temporary player club registration tickets, among others. The data can include data such as a coupon ID, a promotion type, the date a coupon was issued, the time of issuance, the date a coupon was redeemed, the time of redemption, and the location of redemption. Additional information is disclosed in FIG. 10 and FIG. 11 and throughout this specification.

Additionally, data can be collected from other system(s) 112 (of FIG. 1) and incorporated into the PCS 110 (of FIG. 1) database. For example, a game ID, a printer ID, a bill validator ID, a gaming establishment ID, and a redemption location ID, among others.

In one embodiment, the PCS 110 (of FIG. 1) issues one or a plurality of coupons and/or temporary player club registration tickets using indicia including one or a plurality of barcodes, one or a plurality of text, and/or one or a plurality of graphic images, among others, wherein the indicia is generated by a printer such as 104a (of FIG. 1). Additionally, the barcode generated on a coupon includes a sequence number.

In another embodiment, the PCS 110 (of FIG. 1) issues one or a plurality of coupons based on varying prize levels of a promotion.

In another embodiment, the PCS 110 (of FIG. 1) issues one or a plurality of coupons based on one or a plurality of promotions.

In another embodiment, the PCS 110 (of FIG. 1) issues one or a plurality of coupons based on a player's participation and/or a player activity, independent of the participation and/or activity of other players.

In another embodiment, the PCS 110 (of FIG. 1) issues one or a plurality of coupons to replace an already issued coupon thereby adding additional value to the coupon and whereby the already issued coupon is considered redeemed or null and void.

In another aspect of the invention, the PCS 110 (of FIG. 1) issues one or a plurality of coupons based on a patron's participation and/or patron activity in relation to the other business entity, independent of the participation and/or activity of other patrons.

In another aspect of the invention, the PCS 110 (of FIG. 1) issues one or a plurality of coupons at a gaming establishment wherein the coupons are used and redeemed at a game 102 or any point of redemption 116 (both of FIG. 1) of the same or one or a plurality of other gaming establishments.

In another aspect of the invention, the PCS 110 (of FIG. 1) issues one or a plurality of coupons at a gaming establishment wherein the coupons are used and redeemed at any point of redemption 806 (of FIG. 8) of one or a plurality of business entities.

In another aspect of the invention, the PCS 110 (of FIG. 1) issues one or a plurality of coupons at a business entity wherein the coupons are used and redeemed at any point of redemption 806 (of FIG. 8) of the same or one or a plurality of other business entities.

In another aspect of the invention, the PCS 110 (of FIG. 1) issues one or a plurality of coupons at a business entity wherein the coupons are used and redeemed at a game 102 or any point of redemption 116 (both of FIG. 1) of one or a plurality of gaming establishments.

FIG. 7 is a flow chart of a TCT issuance and redemption process in accordance with an exemplary embodiment of the present invention.

The components in this illustration and/or descriptions thereof are previously disclosed in FIG. 1, FIG. 2, and FIG. 6 as well as throughout this specification.

The process begins with insert TCT 702 where a player inserts a temporary player club registration ticket into the bill validator of a game 106a or point of redemption 106b (both of FIG. 1). If the temporary player club registration ticket or TCT is detected 704, the process continues with process sequence number 706 where the PCS 110 (of FIG. 1) can associate a sequence number and/or other number scheme to associate multiple coupons issued to a player. The sequence number and/or other number scheme permit the tracking of a player where the player is known or anonymous in a PTS 504 (of FIG. 5), among others.

If a coupon is not detected, the process returns to insert TCT 702.

Once the sequence number is processed, the process continues with redeem TCT 708 where information related to the player can be processed in a PTS 504 (of FIG. 5), among others and a PTS card can be issued 710.

The process then continues with update database 712 where the TCT 502 (of FIG. 5) database is updated, after which the process ends.

The information stored in the TCT 502 (of FIG. 5) database includes information on the issuance and redemption of such and unique identifiers, among others for coupons such as progressive coupons and temporary player club registration tickets, among others. The data can include data such as a progressive coupon or temporary player club registration ticket ID, a promotion type, the date a coupon or temporary player club registration ticket was issued, the time of issuance, the date a coupon was redeemed, the time of redemption, and the location of redemption.

Additionally, data can be collected from other system(s) 112 (of FIG. 1) and incorporated into the TCT 502 (of FIG. 5) database. For example, a game ID, a printer ID, a bill validator ID, a gaming establishment ID, and a redemption location ID.

In another aspect of the invention, the PCS 110 (of FIG. 1) and TCT system 502 are the same system.

FIG. 8 is a diagram of a couponing system in accordance with an exemplary embodiment of the present invention. Any component can be optional.

The couponing system 100 includes one or a plurality of games 102, 310a and 310b and/or one or a plurality of point of redemption 116 in one or a plurality of gaming establishments 402, 404 and 802, and/or one or a plurality of other business entities 804 anywhere in the world. Each business entity includes one or a plurality of point of redemption 806 which connect to a local host 808 and/or other system(s) 810 such as a point-of-sale system (POS) for data transmission and exchange.

Each game 102, 310a and 310b and/or point of redemption 116 and 806 includes a printer and bill validator, among other peripherals as previous disclosed. Each game and/or point of redemption in a gaming establishment 402, 404 and 802 and/or other business entity 804 and/or peripheral thereof connects to a couponing system 100 for the issuance, tracking, and redemption of coupons and/or prizes offered as well as to other systems 112 for player tracking and play tracking, among others. Other business entities use the couponing system to tap into the market and audience of each connected gaming establishment. This system, for example, allows for lotteries and promotions to be conducted worldwide, nationally, or locally.

Each gaming establishment 402, 404 and 802 is a group of associated properties belonging to the same entity, separate properties belonging to different entities or a combination thereof.

Other business entities 804 include other types of businesses that are non-gaming, in association with a gaming establishment 402, 404 and 802, such as a retail store in a casino shopping center, not in association with a gaming establishment, such as a major department store, or a combination thereof.

The couponing system 100 includes one or a plurality of PCS 110 (of FIG. 1) in use at one or a plurality of gaming establishments 402, 404 and 802 and/or one or a plurality of other business entities 804. Each PCS is hosted by a local host such as Local Promo Host 302 and 808. Each gaming establishment and/or other business entity utilizes the PCS for data exchange and transmission including the issuance, tracking, and redemption of promotional coupons and/or progressive coupons, among others. For example, a PCS in gaming establishment 402 connects to a PCS in one or a plurality of gaming establishments 404 and 802 and/or other business entity 804 for data exchange and transmission where coupons issued at gaming establishment 402 are redeemed in gaming establishments 402, 404, and 802 and/or other business entities 804.

In another embodiment, the couponing system 100 and the PCS 110 (of FIG. 1) are the same system.

A local host such as Local Promo Host 302 and 808 connects to the couponing system 100 and to one or a plurality of games 102, 310a and 310b and/or peripherals thereof and/or one or a plurality of point of redemption 116 and 806 and/or peripherals thereof such as printer, bill validator and/or a device such as a smart box as previously disclosed. In this embodiment, the local host provides for data storage and a local point where the game and/or point of redemption and peripherals thereof connect for data transmission and exchange as well as a connection to the couponing system.

In another embodiment, one or a plurality of games 102, 310a and 310b and/or peripherals thereof and/or one or a plurality of point of redemption 116 and 806 and/or peripherals thereof connect to the couponing system 100 without using a local host 302 and 808.

Additionally, the connection to the couponing system 100 and each PCS 110 (of FIG. 1) uses an Internet, WAN, LAN, dedicated communications link, or shared data line, among others. In another embodiment, the connection and/or data exchange with each PCS and/or peripheral thereof is secured. In another, the connection from a game 102, 310a and 310b and/or point of redemption 116 and 806 and/or peripherals thereof to the PCS is a direct connection as previously disclosed.

In another embodiment, a printer such as 104a and/or bill validator such as 106a (both of FIG. 1) includes one port or interface, which connects to PCS 110 (of FIG. 1) and/or other system(s) 112 and 810 and/or the game controller. For example, in a business entity 804, a printer and/or bill validator connect to the PCS and POS.

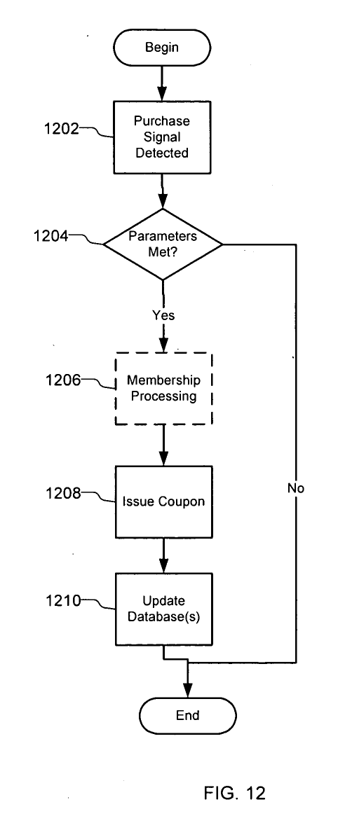

In another embodiment, the couponing system 100 issues one or a plurality of coupons to a patron at a business entity 804 as a result of signaling by the PCS 110 (of FIG. 1) based on purchase metrics 1110, purchase activities 1108, or event 1106 (each of FIG. 11), among others or using none of these. Additional information is disclosed in FIG. 11 and FIG. 12 and throughout this specification.

In another embodiment, the couponing system 110 continually supplies coupons to one or a plurality of patrons, where a patron is tracked using a frequent buyer program, membership rewards program, or anonymously. Additional information is disclosed in FIG. 11 and throughout this specification.

In another embodiment, the couponing system 100 stores information regarding one or a plurality of coupons, the information including issuance and redemption of such and/or unique identifiers, among others.

In another embodiment, the couponing system 100 stores information regarding one or a plurality of promotions, the information including issuance and redemption of such and/or unique identifiers, among others.

In another aspect of the invention, the couponing system 100 stores information regarding one or a plurality of promotional campaigns, the information including usage and/or unique identifiers, among others.

In the operation of an embodiment, other business entity 804 desires to promote a certain product or products in one or a plurality of gaming establishments 402, 404 and 802. The information related to such is created and stored in the couponing system 100. The couponing system downloads the data, including coupon data, to one or a plurality of games 102, 310a and 310b within one or a plurality of gaming establishments. A player playing a game receives a coupon for the certain product or products, the coupon being generated by the printer 104a (of FIG. 1) in the game. The player then can redeem said coupon at the other business entity either by human interface or by point of redemption 806. The redemption data then is transferred and stored in the couponing system, local host either in the other business entity 804, one or a plurality of gaming establishments such as 302, or both.

In the operation of another embodiment, a gaming establishment 402 desires a promotion such as to promote the establishment, an event, or a restaurant thereof. The information related to such is created and stored in the couponing system 100. The couponing system downloads the data, including coupon data, to one or a plurality of other business entities 804. A patron, upon making a purchase, receives a coupon for the promotion, the coupon being generated by a printer in a point of redemption 806 at the other business entity. The patron then can redeem the coupon at the gaming establishment 402, 404 and 802 accordingly, such as by a point of redemption 116. The redemption data then is stored in the couponing system, either in the other business entity, a gaming establishment, or both.

In the operation of another embodiment, a gaming establishment 402 or other business entity 804 desires to run a lottery-type or Keno-type game in association with one or more gaming establishments such as 404 and 802 anywhere in the world. The information related to such is created and stored in the couponing system 100. The couponing system downloads the data, including coupon data, to one or a plurality of gaming establishments and/or other business entities. For example, when a purchase is made at a retail store, the couponing system and a printer thereof generates a coupon for the lottery-type or Keno-type game, of which the patron can verify the results of the game either by visiting an associated gaming establishment, calling a telephone number, or visiting a Web site. Once redeemed, the redemption data is stored in the couponing system.

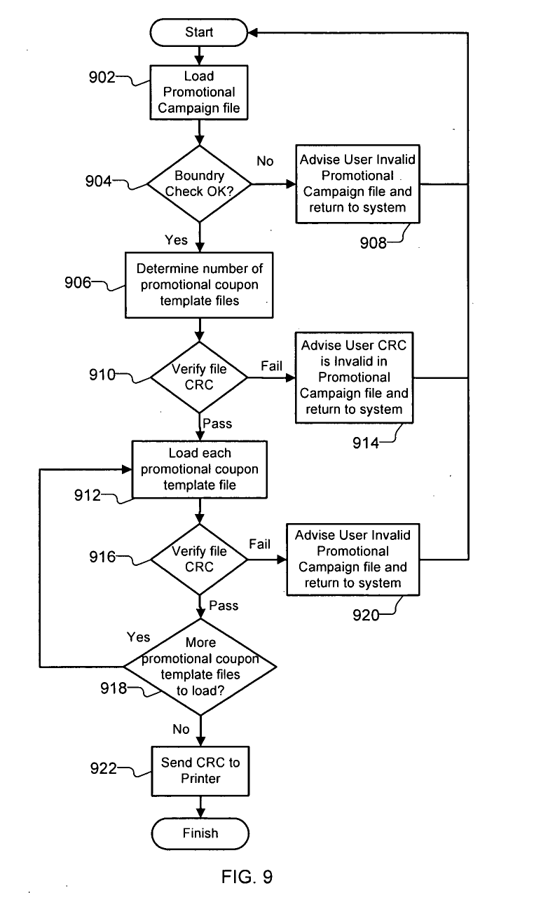

FIG. 9 is a flow chart of a load, check, and verify CRC process for a promotional campaign in accordance with an exemplary embodiment of the present invention.

As illustrated, the process begins with loading promotional campaign data 902. A boundary check is performed 904. If the promotional campaign data passes the boundary check, the process continues with determining the number of promotional coupon template files 906. If the promotional campaign data does not pass the boundary check, the system advises the user and returns to the couponing system 908.

After determining the number of promotional coupon template files, a verify file CRC is performed 910 on the promotional campaign data. If the promotional campaign data passes the CRC verification, the process continues with the loading of each promotional coupon template 912. If the promotional campaign data does not pass the CRC verification, the system advises the user and returns to the couponing system 914.

After loading each promotional coupon template, a verify file CRC 916 is performed on each promotional coupon template in the promotional campaign data. If the promotional campaign data passes the CRC verification, the process continues with the loading of additional promotional coupon templates 918. If the promotional campaign data does not pass the CRC verification, the system advises the user and returns to the couponing system 920.

After loading all promotional coupon templates is complete, the process completes with the CRC being sent to the printer 922.

FIG. 10 is an illustration of an exemplary promotional database, which includes defined coupons and triggers in accordance with an exemplary embodiment of the present invention.

FIG. 10 illustrates trigger matrix logic and process within a printer such as 104a, the couponing system 100 (both of FIG. 1 and throughout) or portions shared between the two, depending on where data is processed. At the top of the diagram are exemplary different logical triggers or play metrics utilized in a printer for initiating printing of the coupons. The five examples given are: date 1002, time 1004, frequency of issuance 1006, duration of play 1008, and other parameters 1010 such as player I.D. 1014, amount of money in play 1012, player class 1016, cashout amount 1018, special 1020, and the like. In the lower part of the diagram is the coupon database stack 1022. The stack of coupons are a plurality of pre-defined coupons 1024, 1026, and 1028 which can printed anytime a trigger or set of trigger conditions to which they are associated are satisfied. These trigger conditions can operate independently or in logical combination. The coupon selector logic module 1030 shown is tasked with analyzing trigger information as it becomes available and determine which coupon should be printed 1032 in response to the information. Additional information is more fully detailed in U.S. patent application Ser. No. 11/502,888, entitled “METHODS AND APPARATUS FOR A PROMOTIONAL COUPONING SYSTEM”, filed Aug. 10, 2006, the contents of which are hereby incorporated by reference as if stated herein in full.

Additional processing, not shown, occurs in the couponing system 100 (of FIG. 1) where the amount of coupons permitted in the campaign, an additional randomness of issue can be applied, and other possible global promotional campaign parameters may be checked before print authorization.

In addition, the play metrics may include: anytime a cash-out voucher is printed, printing of a cash-out voucher for greater than, equal to, or less than a specified amount of money, an amount of money wagered over a particular time period, an amount of money won over a particular time period, an amount of money lost over a particular time period, a duration of play on the gaming machine such as 102 (of FIG. 1), anytime a player adds money or credits to the gaming machine in an amount greater than, equal to or less than a specified amount, a time when the gaming machine is played or cashed-out, a day when the gaming machine is played or cashed-out, a date when the gaming machine is played or cashed-out, an average percentage of the maximum wagering on the gaming machine which the player's activity represents, a random percentage chance that a coupon will be issued when a player cashes out, participation of a player in a frequent player club, a player's birthday date, for participating frequent player club members, classification of the player as applied to modify any play metrics.

In one embodiment, a printer such as 104a (of FIG. 1) downloads from the couponing system 100 (of FIG. 1) the play metrics and analyzes gaming machine activity 1012 passed to it by the couponing system using the play metrics. The printer then produces a coupon 1032 when the play metrics are satisfied.

In another embodiment, the couponing system 100 (of FIG. 1) further includes a database 1034 storing a set of control parameters used to select a type and quantity of coupons to issue related to play metrics used to trigger issuance of coupons, the control parameters operating separately or in combination with each coupon.

In another embodiment, a printer such as 104a (of FIG. 1) further includes a database storing a set of control parameters which are used to select a type and quantity of coupons to issue related to play metrics used to trigger issuance of coupons, the control parameters operating separately or in combination with each coupon.

In another embodiment, the control parameters include a total quantity of a coupon is issued before the coupon is retired, a frequency of issuance of a coupon, one issued every time a specified number of trigger events occurs, a frequency of issuance of a coupon based on a random chance of one in every so many trigger events, an alternative coupon should a particular coupon fail to print for lack of satisfying all of the coupon's play metrics or the coupon's specified set of control parameters.

FIG. 11 is an illustration of an exemplary point-of-sale database, which includes metrics and triggers in accordance with an exemplary embodiment of the present invention.

FIG. 11 is similar to FIG. 10. This figure illustrates the trigger matrix logic and process within a printer such as 104a, the couponing system 100 (both of FIG. 1) and the POS or portions shared, depending on where data is processed. At the top of the diagram are exemplary different logical triggers or purchase metrics utilized in a printer for initiating printing of the coupons. The six examples given are: date 1102, time 1104, purchase event(s) 1106, purchase activities 1108, purchase metrics 1110, and other parameters 1112.

The purchase event(s) 1106 include a sale, a contest, or a sweepstakes, among others.

The purchase activities 1108 include when a selected item or items are purchased by a patron, among others.

The purchase metrics 1110 include an amount spent such as a specific amount spent or a minimum amount spent, purchase type such as a specific purchase or purchases, a cash transaction, and a charge transaction, among others.

The other parameters 1112 include a POS location 1114, a POS I.D. 1116, patron I.D. 1118, patron birthday 1120, patron participation 1122, patron activity 1124, and patron tracking 1126, among others.

In the lower part of the diagram is the coupon database stack 1128. The stack of coupons are a plurality of pre-defined coupons 1130, 1132, and 1134 which can printed anytime a trigger or set of trigger conditions to which they are associated are satisfied. These trigger conditions can operate independently or in logical combination. The coupon selector logic 1136 module shown is tasked with analyzing trigger information as it becomes available and determine which coupon should be printed in response to the information.

Additional processing, not shown, occurs in the couponing system 100 (of FIG. 1), the POS, or both where the amount of coupons permitted in the campaign, an additional randomness of issue can be applied, and other possible global promotional campaign parameters may be checked before print authorization.

In one embodiment, a printer such as 104a downloads from the couponing system 100 (both of FIG. 1), the POS, or both, the purchase metrics 1110 and analyzes purchase activity 1108 passed to it using the purchase metrics. The printer then produces a coupon 1138 when the purchase metrics are satisfied.

In another embodiment, the couponing system 100 (of FIG. 1), the POS, or both further includes a database 1140 storing a set of control parameters used to select a type and quantity of coupons to issue related to purchase metrics 1110 used to trigger issuance of coupons, the control parameters operating separately or in combination with each coupon.

In another embodiment, a printer such as 104a (of FIG. 1) further includes a database storing a set of control parameters which are used to select a type and quantity of coupons to issue related to purchase metrics used to trigger issuance of coupons, the control parameters operating separately or in combination with each coupon.

In another embodiment, the control parameters include a total quantity of a coupon is issued before the coupon is retired, a frequency of issuance of a coupon, one issued every time a specified number of trigger events occurs, a frequency of issuance of a coupon based on a random chance of one in every so many trigger events, an alternative coupon should a particular coupon fail to print for lack of satisfying all of the coupon's purchase metrics or the coupon's specified set of control parameters.

In another embodiment, the couponing system 100 (of FIG. 1), the POS, or both stores information regarding one or a plurality of coupons, the information including issuance and redemption of such and/or unique identifiers, among others.

In another embodiment, the couponing system 100 (of FIG. 1), the POS, or both stores information regarding one or a plurality of promotions, the information including issuance and redemption of such and/or unique identifiers, among others.

In another embodiment, the couponing system 100 (of FIG. 1), the POS, or both stores information regarding one or a plurality of promotional campaigns, the information including usage and/or unique identifiers, among others.

In another embodiment, the couponing system 100 (of FIG. 1) and the POS are the same system.

FIG. 12 is a flow chart of a purchase detection and coupon issuance process in accordance with an exemplary embodiment of the present invention.

As illustrated, the process begins with a purchase made signal being detected 1202. This signal can come from a cash registered connected to the couponing system 100 (of FIG. 1). The purchase is checked against parameters set for the issuance of a coupon. These parameters are based on purchase metrics 1110, purchase activities 1108, or events 1106 (each of FIG. 11), among others or using none of these. Additional information is disclosed in FIG. 11. If the parameters are met 1204, the process optionally continues with membership processing 1206 where the patron and data related to the patron can be processed according to a frequent buyer program or membership rewards program, among others; otherwise, the process ends.

The process then continues with issue coupon 1208 where one or a plurality of additional coupons is issued to the patron. In update database 1210, the couponing system 100 (of FIG. 1) database and/or other databases such as a membership database is updated after which the process ends. Additional details are disclosed in FIG. 6.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A couponing system for progressive couponing and worldwide couponing, comprising
a central processing unit for the issuance, tracking, and redemption of coupons;
a plurality of games connected to the central processing unit for issuing and redeeming coupons; each game further comprising:
a printer for issuing coupons;
a bill validator for redeeming coupons;
a smart box connected to the printer, bill validator and other peripherals of the game;
a plurality of point of redemption connected to the central processing unit for issuing and redeeming coupons; each point of redemption further comprising:
a printer for issuing coupons;
a bill validator for redeeming coupons;
a connection to other systems such as a player tracking system (PTS) and point of sale system (POS).

2. A method of a couponing system, comprising:
a central processing unit issuing one or a plurality of coupons based on varying prize levels to a player based on the player's participation and/or activity, independent of the participation and activity of other players;
a printer connected to the central processing unit for the transfer of data indicative to coupons, the printer generating each coupon;
a bill validator connected to the central processing unit for the transfer of data indicative to the redemption of each coupon;
